(19) United States
(12) Patent Application Publication
(10) Pub. No.: US 2002/0142903 A1
(43) Pub. Date: Oct. 3, 2002

(54) Coating tool

(75) Inventors: Yoji Tominaga, Tsushima-shi (JP); Hisataka Uruta, Nagoya-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: GEN Maintenance Technology Inc., Tsushima-shi (JP)

(21) Appl. No.: 10/107,381

(22) Filed: Mar. 27, 2002

(30) Foreign Application Priority Data
Mar. 27, 2001 (JP) 91295/2001

(51) Int. Cl. B05C 1/08; B25F 5/02

(52) U.S. Cl. 492/13

(57) ABSTRACT

The present invention provides a roller fixed coating tool including a grip and an application roller held by a frame extended from the grip, which tool has a support structure capable of non-rotatably supporting the application roller at two or more predetermined positions upon rotation of the application roller about the axis thereof, wherein coating is done while non-rotatably supporting the application roller at each of the two or more predetermined positions. According to the present invention, almost all the surface of the periphery of the application roller can be effectively used, and coating film forming with less air bubble entrainment can be continued for a relatively long period. In addition, since any typical application roller can be used for the coating tool of the present invention, the cost necessary for the entire coating work can be greatly reduced as compared to conventional coating work.

### TECHICAL FIELD OF THE INVENTION

The present invention relates to a coating tool.

### BACKGROUND OF THE INVENTION

For the purpose of protecting surface and improving appearance of floor, wall and the like, a liquid coating agent is generally applied and solidified (cured) to form a film. For coating a liquid coating agent, spraying with a spray gun, brushing, roller coating, coating finish with mouton and the like have been conventionally used.

However, spraying with a spray gun is problematic in terms of influence to human body and environmental hygiene, because a liquid coating agent scatters during coating. Brushing takes long to coat a wide area, is poor in work efficiency, and often leaves brush marks. Roller coating may produce irregular surfaces of a coating film, because rollers entrain air while rotating. Coating finish using mouton and the like easily leaves traces of drawing on a coating film and also poses problem of workability because it requires a great force for drawing. Any method conventionally employed for coating poses some problem. Of such methods, roller coating is most frequently used, because it is relatively easy and simple and affords better workability than other methods.

A coating tool for roller coating has an application roller. The roller typically has a surface having a fibrous layer, and the kind of a fiber (wool) thereof, length of gigging, density and the like of the layer are adjusted to achieve a desired thickness and smooth surface of the paint film. Even with such adjustment of the material and properties of the surface of the application roller, the above-mentioned problem caused by air bubble entrainment still remains to be solved. When a coating film shows air bubble entrainment by roller coating, the surface of the coating film is stroked with a brush after coating. JP-A-9-206661 proposes a coating tool equipped with a stopper to stop rotation of an application roller, with which the rotation of a roller is stopped after coating and the surface of the coating film is stroked with the surface of the roller on halt, thereby saving the trouble of changing the coating tool to a brush. The above-mentioned stopper comprises a rod having a tip of a certain shape (e.g., sharp tip or fork) capable of fixing an application roller, which is set inside the grip or on the side of a support frame of the roller, and which is to be pressed against the body of the application roller after coating, wherein the tip is away from the application roller in the normal state (during coating). Consequently, when rotation of the roller is stopped, a stopper mark (mark of a stopper pressed against the roller) is left on the periphery of the application roller. When the coating film is coated again after stroking the surface of the coating film, coating marks (unnecessary lines) are tend to be produced due to the uneven fiber (wool) containing a stopper mark. Moreover, the grip has an unnecessarily large size and the mechanism for making the rod moveable back and forth makes handling of the coating tool difficult, thus degrading the workability during coating. Even if there is no need to change the tool to a brush, the step of stroking the coating film after coating inevitably extends the total work time.

Furthermore, a floor finishing applicator (PADCO) is commercially available, which claims that coating can be finished without the above-mentioned air bubble entrainment. This floor finishing applicator consists of, as shown in FIG. 8, an application member 61 made of a rod having a section (plane perpendicular to the length direction thereof) of about a C-shape and a support 64 composed of a round bar 63 connected to a grip 62, which forms an about T-shape. When in use, the round bar 63 of the support 64 is fitted into a concave groove 61a formed in the application member 61 and used as a coating tool. Using this floor finishing applicator, a liquid coating agent cast on a floor is extended with a peripheral face (fixed surface) of the application member 61, whereby a flat coating film can be formed without many air bubbles. This floor finishing applicator, nevertheless, is uneconomical, because only a part of the peripheral face of the application member 61 is actually used in contact with the floor face. When this part is deteriorated, the entire application member 61 needs to be exchanged. Frequent exchange of the application member 61 is not economical. Moreover, the above-mentioned application member 61 having a section of about a C-shape is exclusively joined with the support 64. Therefore, widely-used application members, such as application rollers for roller coating, cannot be used. This member needs to be produced as a special member, which increases its cost as well as the cost necessary for the entire coating work.

### SUMMARY OF THE INVENTION

In view of the above-mentioned situation, the present invention provides a coating tool having a simple structure and superior workability (handling property of coating tool itself) during coating, which is capable of forming a coating film with less air bubble entrainment over a relatively extended period of time without frequently changing an application member.

To achieve the above-mentioned object, the present invention has the following characteristic structure.

(1) A roller fixed coating tool comprising a grip and an application roller held by a frame extended from the grip, which tool has a support structure capable of non-rotatably supporting the application roller at two or more predetermined positions upon rotation of the application roller about the axis thereof, wherein coating is done while non-rotatably supporting the application roller at each of the aforementioned two or more predetermined positions.

(2) The roller fixed coating tool of the above-mentioned (1), wherein the support structure affords a non-rotatable support of the application roller on at least one end of the application roller.

(3) The roller fixed coating tool of the above-mentioned (1), wherein the application roller is non-rotatably supported at 3 or 4 predetermined positions.

(4) A roller fixed coating tool comprising

an application roller having a concave to receive a bearing cap on both ends, and

a grip joined with a first frame having a protruding support shaft to support one end of the application roller and a second frame having a protruding support shaft to support the other end of the application roller, which comprises a sliding mechanism set on at least one connection between the frames and the grip to enlarge or shorten a distance between the two support shafts,

the support shafts of the aforementioned first frame and the second frame each having, on a tip thereof, a rotatable bearing cap, the bearing cap having two or more concaves for preventing rotation of the roller, at about the same intervals on a circumference of a circle concentric with the axis of the support shaft, which circle being defined on an opposite end of the bearing cap from the side where it is fitted into a concave on the end of the application roller, and the aforementioned first frame and the second frame each having a pin whose tip is to be inserted into said concave for preventing rotation of the roller,

wherein the application roller is rotatably supported by sliding at least one of the aforementioned first frame and the second frame and fitting the bearing cap on the tip of both support shafts into the concaves on both ends of the application roller, and

wherein the application roller is non-rotatably supported at predetermined positions about the axis upon rotation of the rotatable application roller about the axis to insert the tip of the aforementioned pin into one desired concave of the two or more concaves formed on each bearing cap on both ends for preventing rotation of the roller.

(5) The roller fixed coating tool of the above-mentioned (4), wherein the pin is biased by a spring to normally keep the tip inserted into the concave for preventing rotation of the roller and pulled at its rear end when the aforementioned tip is evacuated from the concave.

(6) The roller fixed coating tool of the above-mentioned (4), comprising 3 or 4 concaves for preventing rotation of the roller.

(7) The roller fixed coating tool of the above-mentioned (1) or (4), which is for coating an aqueous emulsion or an aqueous dispersion.

The coating tool of the present invention affords coating of a liquid coating agent (hereinafter to be also referred to as an application solution) with a periphery of a fixed application roller. This has an effect that air entrainment associated with roller coating can be prevented and a coating film suffering from less air bubble entrainment and superior in smoothness can be formed. Furthermore, since the application roller can be fixed at two or more predetermined positions (designated positions) on a circle formed by rotation of the application roller about its axis, a new periphery of the application roller can be used for coating when the part of the periphery of the application roller first applied for the coating is deteriorated. By repeat operation of this method, the entire periphery of the application roller can be efficiently used. As a result, frequent exchange of the application member (application roller) is not necessary, and a coating film with less air bubble entrainment can be formed for a relatively long period of time.

The coating tool of the present invention permits use of a commercially available application roller. Therefore, the optimum length, diameter and weight of a roller and the kind of the material of a roller cover (kind, length, density of fiber etc.) can be determined according to the coating area, the kind of a liquid coating agent, a desired coating thickness and the like.

According to the coating tool of the present invention, since at least one end of the application roller is non-rotatably supported (fixed), unnecessary marks are not left on the coating surface (periphery) of the application roller. Particularly, when the application roller is non-rotatably supported at both ends of the application roller, the application roller can be more stably fixed on the frame and coating workability and quality of the coated film are improved.

In roller coating, volatile substances in a liquid coating agent evaporate from the roller surface. Consequently, the viscosity of and the nonvolatile substances in the liquid coating agent change, and the obtained coating film has poor uniformity. By the use of the coating tool of the present invention, where the roller is fixed for coating, the liquid coating agent is in contact with a less amount of the air. Accordingly, the above-mentioned problem can be solved and a uniform coating film can be easily formed.

### BRIEF DESCRIPTION OF THE DRAWINGS

FIG. 1 is a front view of a coating tool according to one embodiment of the present invention.

FIG. 2 is a partial deal drawing of the coating tool of FIG. 1.

FIG. 3 is an enlarged view of essential parts of the coating tool of FIG. 1, wherein FIG. 3(a) is a front view of a bearing cap and FIG. 3(b) and FIG. 3(c) are side views of a support shaft protruding side of the frame.

FIG. 4 is a plan view of a frame of the coating tool of FIG. 1.

FIG. 5 is a sectional view of an application roller (roller itself) of the coating tool of FIG. 1.

FIG. 6 is a side view schematically showing the coating tool of FIG. 1 in use.

FIGS. 7(a) and 7(b) are side views schematically showing the coating tool of FIG. 1 in use.

FIG. 8 is a perspective view of a conventional coating tool.

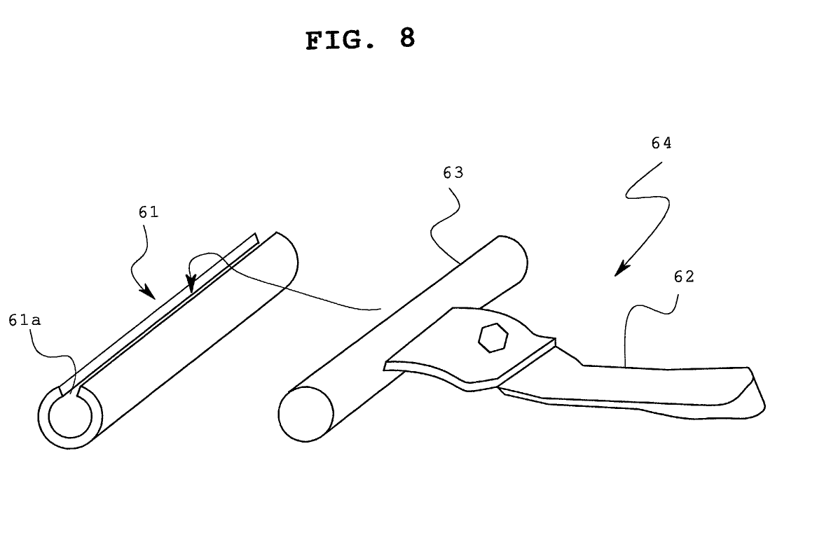

### DETAILED DESCRIPTION OF THE INVENTION

The present invention is explained in detail in the following.

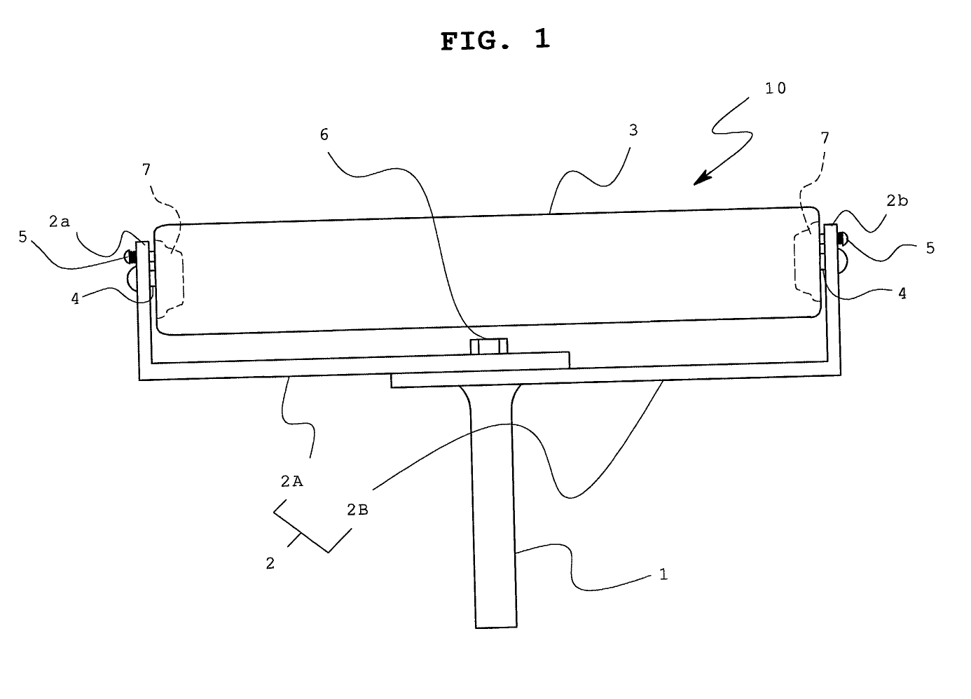

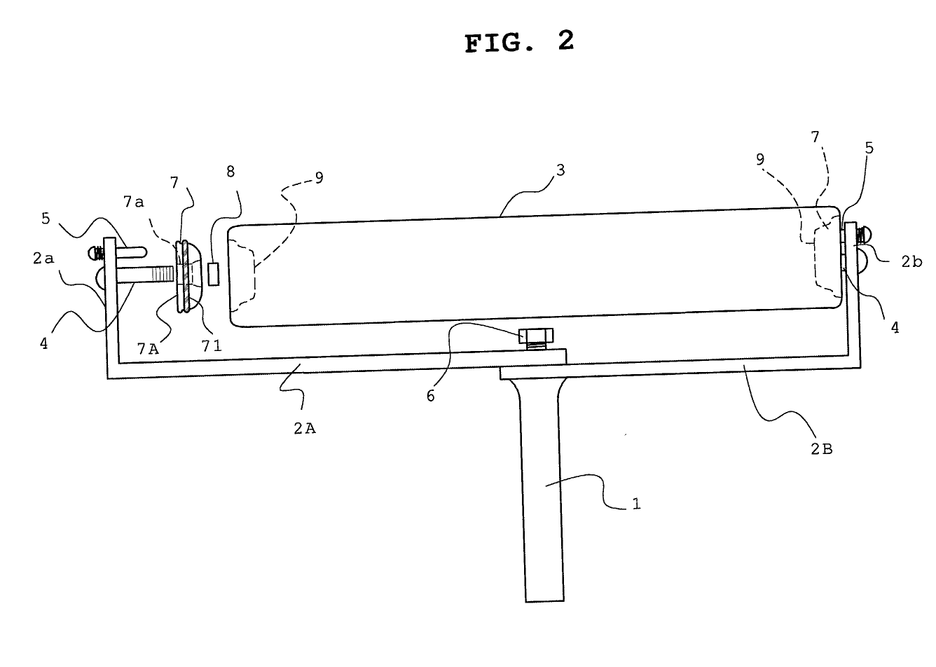

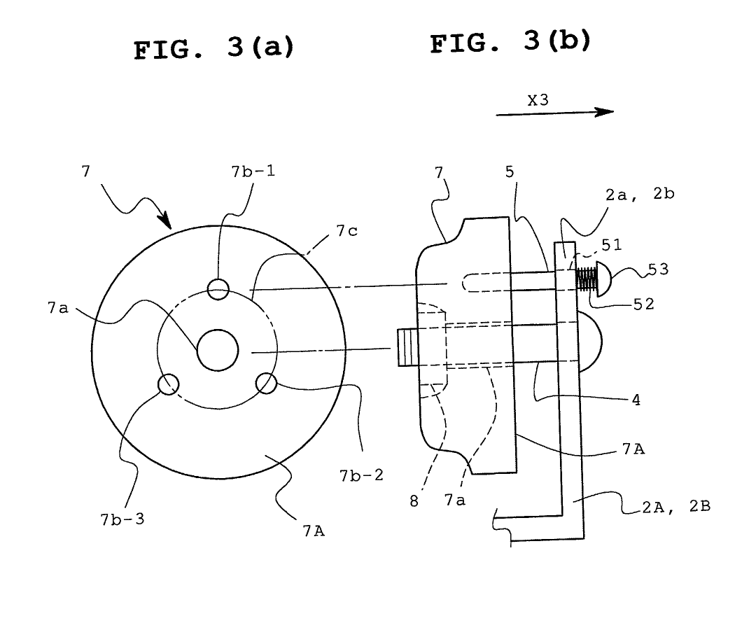

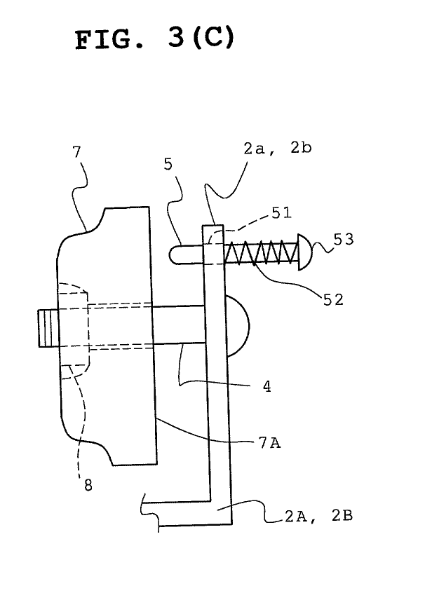

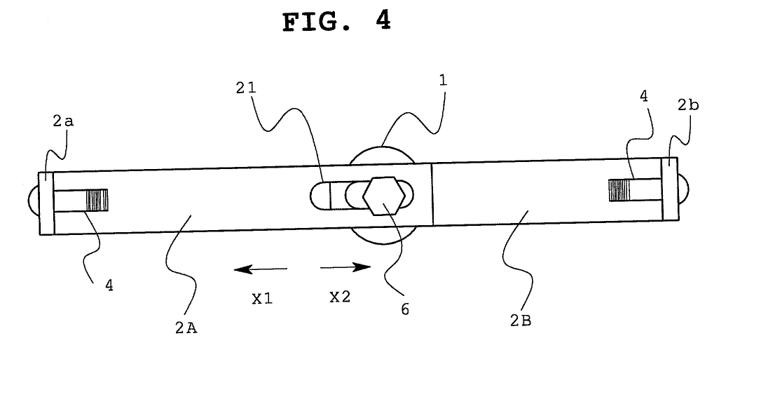

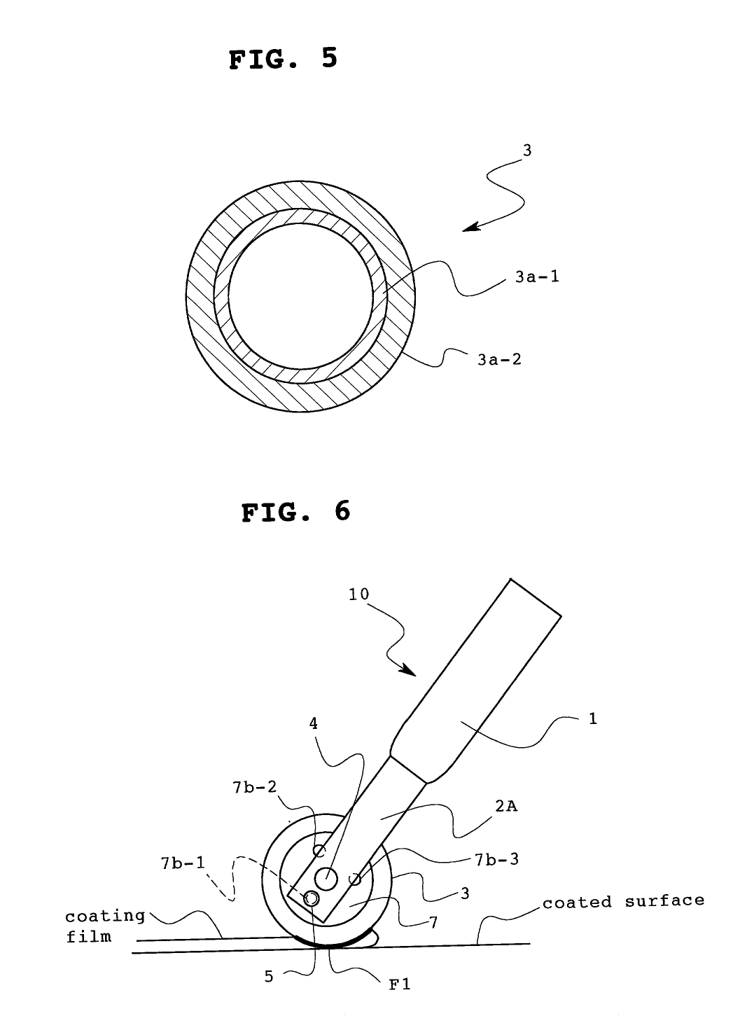

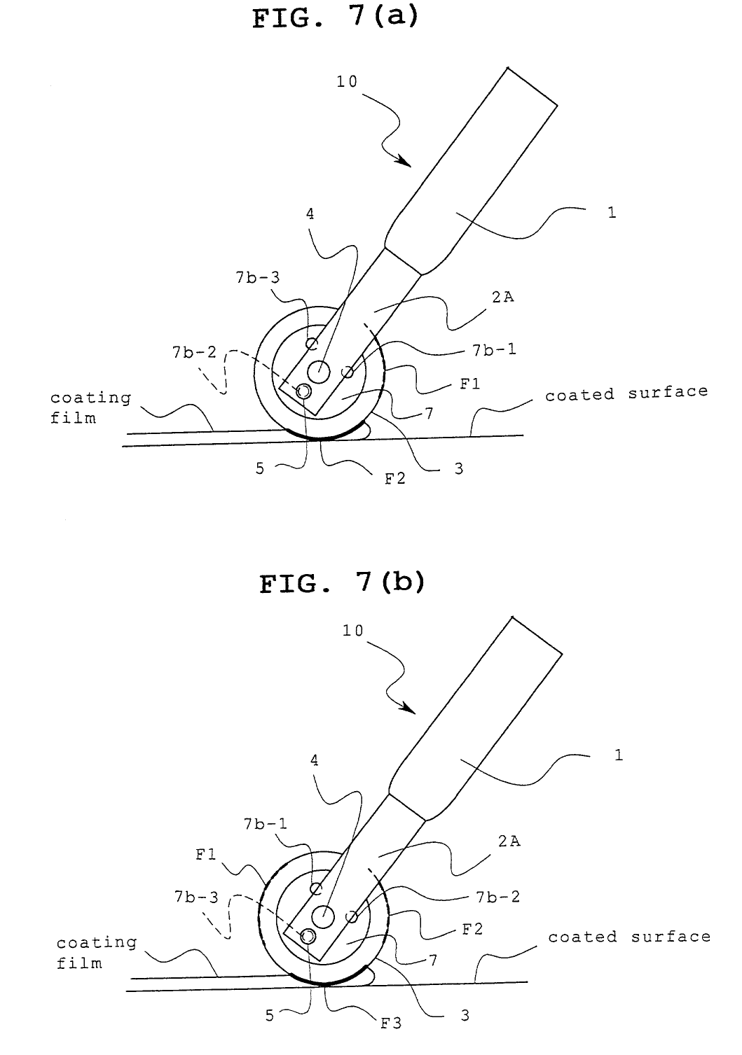

FIG. 1-FIG. 4 show a coating tool according to one embodiment of the present invention, wherein FIG. 1 is a front view, FIG. 2 is a partial deal drawing, FIG. 3 is an enlarged view of the essential parts (frame end and bearing cap), FIG. 4 is a plan view (plan view of frame) when the application roller is removed from the frame, FIG. 5 is a sectional view of the application roller, and FIGS. 6, 7 explain coating work using the coating tool.

A coating tool 10 has a grip 1, a frame 2 extended from the grip 1 and an application roller 3 (hereinafter to be also simply referred to as a roller) supported by the frame 2.

The application roller 3 consists of a hollow cylindrical core 3a-1 and a fibrous or porous cover 3a-2 covering the periphery (FIG. 5). The roller has a concave 9 (FIG. 2) for receiving a bearing cap on both of its ends.

The frame 2 consists of a first frame 2A and a second frame 2B formed by bending a narrow long plate in an L-shape. These are connected to the grip 1 respectively at one end with a bolt 6, with the other end being a support of the application roller 3. As shown in FIG. 4, the connection between grip 1 and the first frame 2A and the second frame 2B has a long hole 21. The bolt 6 can be screwed together with the tip of the grip 1 at an optional position in the longitudinal direction of the long hole 21. In other words, the first frame 2A and the second frame 2B can be slid in the directions of arrows X1, X2 in FIG. 4. In FIG. 4, the pin to be explained later is not shown for convenient explanation.

A support shaft 4 to be the rotation axis of the application roller is protruded on the ends 2a, 2b of the first frame 2A and the second frame 2B that support the application roller 3. The tip of the support shaft 4 has a bearing cap 7. Furthermore, a pin 5 is set near the support shaft 4 to prevent rotation of the application roller (FIG. 3).

The bearing cap 7 has a through-hole 7a through which a support shaft 4 can pass. The support shaft 4 is passed through the through-hole 7a and a nut 8 is screw-engaged with a helically-cut tip of the support shaft 4, whereby the bearing cap 7 is rotatably (i.e., idling state) set relative to the support shaft 4 (FIG. 2, FIG. 3). As shown in FIG. 3(a), on the support shaft side 7A of the bearing cap 7, three concaves 7b-1 to 7b-3 to prevent rotation of the application roller are formed at about the same intervals on the circumference of a circle 7c around the through hole 7a that passes through the support shaft 4, which circle being concentric with the through-hole 7a [circle having the same center point with the axis of support shaft 4, the axis being the axis of the application roller 3]. On the periphery side, a packing (O ring) 71 is set (FIG. 2). Here, a packing (O ring) 71 may be constantly set on the periphery side of the bearing cap 7, but may be set when the bearing cap 7 is fitted into a concave 9 on both ends of the application roller 3.

Only when the bearing cap 7 is fitted into the concave 9 on the both ends of the application roller 3, can the application roller 3 rotate about the support shaft 4 as the rotation axis.

As shown in FIG. 3(b), a tip of the pin 5 wearing a coil spring 52 is inserted into a through hole 51 formed in frame 2A, 2B (end 2a, 2b). One end of the coil spring 52 is stopped by the convex 53 on its rear end, and the other end of the coil spring 52 is stopped by frames 2A, 2B (end 2a, 2b). The pin 5 is normally in the state shown in FIG. 3(b), wherein its tip is inserted into the concave (one of the concaves 7b-1 to 7b-3) formed on the bearing cap 7 to prevent rotation of the application roller. By pulling the convex 53 on the rear end in the direction of an arrow X3 in FIG. 3(b), it turns into the state shown in FIG. 3(c) wherein it is pulled out (evacuation state) from the concave (concaves 7b-1 to 7b-3) formed on the bearing cap 7 to prevent rotation of the application roller and restore the original state (shown in FIG. 3(b)) by releasing convex 53 on the rear end, due to the resilience of coil spring 52. That is, the tip of the pin 5 in a normal state is inserted into the concave to prevent rotation of the roller, thereby to make the application roller 3 non-rotatable (application roller in a fixed state).

The application roller 3 is set on the frame 2 as follows. That is, a bolt 6 is loosened and the first frame 2A and the second frame 2B are slid to broaden the distance between bearing caps 7 attached to the respective support shafts 4, between which an application roller 3 is set. In this state, the first frame 2A and the second frame 2B are slid to fit the bearing cap 7 into the concaves 9 on both ends of the application roller. As a result, the bearing cap 7 is firmly fixed on the both ends of the application roller 3 via a packing (O ring) 71, whereby the application roller 3 is supported between the first frame 2A and the second frame 2B (FIG. 1). At this point, the tip of each pin 5 attached to the first frame 2A and the second frame 2B is inserted into each concave (7b-1 to 7b-3) to prevent rotation of the roller. The concaves are formed in the bearing cap 7 fitted into the both ends of the application roller 3. At this time, the application roller 3 cannot rotate due to the pin 5.

The coating tool 10 of the present invention is applied to a coating work with the application roller 3 in a non-rotatable state (fixed state). FIG. 6 shows a coating tool 10 coating a liquid coating agent on a surface to be coated with the application roller 3 in a fixed state, wherein the tip of the pin 5 is inserted into the concave 7b-1 on the bearing cap 7 to prevent rotation of the roller, thereby to make the application roller 3 non-rotatable. As shown in FIG. 6, the coating is done with the coating tool 10 while a predetermined curve face F1 of the periphery of the application roller 3 in a fixed state is in sliding contact with the surface to be coated. Therefore, the application roller 3 includes the air less often, and a flat coating film free of air bubbles can be formed on the surface.

After repeat coating work, however, the curve face (F1 in FIG. 6) of the periphery of the application roller 3 to be in contact with the coated surface to be coated becomes deteriorated (for instance, the solvent etc. in the liquid coating agent are evaporated and the part of a cover that comes into contact with the liquid is partially solidified and the like). As a result, a coating film having a desired thickness cannot be formed, or paint marks (unnecessary lines) are left, preventing fine coating state. When such phenomenon becomes noticeable, the part of the periphery of the roller to be in contact with the surface is changed, as shown in the following.

By pulling convex 53 on the rear end of each pin 5 set on the ends 2a, 2b of the first frame 2A and the second frame 2B, the pin 5 is removed from the concave (concave 7b-1) in the bearing cap 7 on the both ends of the application roller 3, thereby to prevent rotation of the roller (FIG. 3(c)). The application roller 3 is rotated for a given angle (120 degrees here) about the axis, and the pin 5 is inserted into a different concave (e.g., concave 7b-2) to prevent rotation of the roller. In this way, the application roller 3 is fixed at a predetermined position about the axis, which is different from the aforementioned position, as shown in FIG. 7(a). The coating can be done by changing the curve face on the periphery of the application roller 3 to be in contact with the coated surface from the aforementioned F1 to F2.

As is clear from the foregoing explanation, by pulling out the pin 5 from the concave, rotating the application roller 3 for a given angle (120 degrees) and inserting the pin 5 into a concave (concave 7b-3) in the same manner as above, a curve face F3 on the periphery of the application roller 3 can be brought into contact with the surface for coating work, as shown in FIG. 7(b).

According to the coating tool 10, a coating film with less air bubble entrainment can be formed using the application roller 3, and almost all the surface on the periphery of the application roller can be effectively used, because it has a support structure wherein the application roller 3 is non-rotatably supported at three predetermined positions on the rotation circle about the axis thereof, and the application roller 3 can be non-rotatably supported at each position of the three predetermined positions to apply coating. Therefore, a coating film with less air bubble entrainment can be formed stably over an extended period of time, and the application roller 3 can be used effectively until nearly all the peripheral surface is deteriorated. In addition, the part of the periphery of the application roller to be used for coating can be easily changed by inserting and removing the pin 5 biased with a spring, from and into the concave to prevent rotation of the roller attached to the frame. The operation is convenient, the structure of the coating tool as a whole is simple, and workability during the coating work is fine.

The coating tool described in JP-A-9-206661 referred to as a conventional technique has a stopper to cease the rotation of the application roller. This stopper functions by pressing or thrusting a rod having a fork or needle tip against the periphery of the application roller, which works for stopping the rotation of the application roller but tends to leave a fiber (wool) mark, which is the mark made by the stopper on the periphery of the application roller. In addition, the solvent in a liquid coating agent and the like adhered to the entire surface of the application roller is evaporated and the part of a cover that comes into contact with the liquid tends to solidify partially, and paint marks (unnecessary lines) are easily left by coating with the surface having a fiber (wool) mark.

The position to fix the roller is optionally determined upon rotation of the application roller about the axis, which cannot be determined from the first. In contrast, with the above-mentioned coating tool 10 of the present invention, the application roller 3 can be fixed at several predetermined positions (3 positions) upon rotation about the axis, and the coating can be applied using a given part of the periphery of the application roller 3. Consequently, almost all the surface of the periphery of the application roller can be efficiently used.

The coating tool 10 of the above-mentioned embodiment has a constitution where the application roller 3 is non-rotatably supported at three predetermined positions on rotation about the axis thereof (changed at roller rotation angle of 120 degrees) and the coating is performed using three different parts F1-F3 arranged in the peripheral circumference of the application roller 3. In the present invention, the application roller 3 may be non-rotatably supported at 2, or 4 or more predetermined positions. In this case, the concaves to prevent rotation of the roller can be formed in the bearing cap 7 at an interval corresponding to the predetermined positions. In the case of supporting at two predetermined positions, for example, the concaves are formed at two positions 180 degrees away from each other on the circumference of circle 7c, and in the case of supporting at 4 predetermined positions, the concaves to prevent rotation of the roller are formed at 4 positions 90 degrees away from each other on the circumference of circle 7c.

Depending on the size of the outer diameter of the application roller 3, the application roller is preferably fixed at 3 or 4 predetermined positions to bring the periphery thereof into contact with the surface for coating, in consideration of the width of the periphery of the application roller in the fixed state to be in contact with the surface for coating.

The above-mentioned coating tool 10 has a constitution wherein the both of the first frame 2A and the second frame 2B slide with respect to grip 1. It is possible to make only one of them slide with respect to the grip 1.

While the coil spring 52 to bias the pin 5 is set on the outside (surface opposite from the protrusion of support shaft 4) of the ends 2a, 2b of the first frame 2A and the second frame 2B, this coil spring may be set in the inside (surface on the side of protrusion of support shaft 4) of the ends 2a, 2b.

It is also possible to make the pin 5 not a spring but a screw. In other words, the pin 5 may be screwed together into a through-hole 51 formed in the ends 2a, 2b of the first frame 2A and the second frame 2B, whereby the pin 5 can enter or extract from the concave formed in the bearing cap 7, thereby to prevent rotation of the roller.

The packing (O ring) 71 to be set on the outside of the bearing cap 7 is not always necessary if the bearing cap 7 as it is can be fitted into the concave 9 on the both ends of the application roller 3 and the two can be tightly fixed. It is preferable to use a packing (O ring) 71 to ensure more stable fixing between them. The material of the packing (O ring) is not particularly limited and various rubbers and/or resins can be used. In view of solvent resistance and the like, chloroprene rubber, nitrile rubber, butyl rubber, acrylic rubber, fluorine rubber and the like are preferable.

In the present invention, the materials of the grip, frame and bearing cap and the like are not particularly limited, and these can be formed and/or processed from various materials (resin, rubber, metal and the like). While the materials of the support shaft and pin to be provided on the frame are not particularly limited, a material having the strength to support the application roller in a non-rotatable state (fixed state) during coating work is selected from various materials (resin, rubber, metal and the like) for use.

The material of the hollow cylindrical core 3a-1 of the application roller 3 is not particularly limited, but paper tubes and plastic tubes are preferable from the aspects of light weight roller, cost and the like. The material of the cover 3a-2 is not particularly limited, either. A cover conventionally used for an application roller for roller coating, such as natural wool, pure wool, mohair, synthetic fiber or woven fabric or non-woven fabric made from a wool blend composed of two or more of these, polyurethane foam, vinyl acetate foam and the like, can be used as it is. Of the exemplified, synthetic fiber (oolong fiber) is preferable. As the application roller, one conventionally used for roller coating can be used as it is.

The coating tool of the present invention can be used for coating of various liquid coating agents. A liquid coating agent is a material for film, which is applied for the purpose of protection of an object surface (coated surface) or imparting a good appearance. Examples thereof include paint, polish, wax, surface treatment agent and the like. These liquid coating agents include non-solvent type agents and solvent type agents. The coating tool of the present invention can be used for coating both types of liquid coating agents. As the solvent type, organic solvent type agents (examples of organic solvent: ethyl acetate, butyl acetate, methanol, ethanol, isopropyl alcohol, mineral spirit etc.) and aqueous type agents (examples are aqueous solution, aqueous emulsion, aqueous dispersion etc.) are included. The coating tool of the present invention is particularly preferable for coating a liquid coating agent, such as aqueous emulsion and aqueous dispersion, from among the aqueous type agents. Because liquid coating agents, such as aqueous emulsion and aqueous dispersion, become insoluble in a coating solution on an application roller after evaporation of volatile substances therein, the roller needs exchange when applied to roller coating. With the coating tool of the present invention, however, since the roller is not rotated, evaporation of the volatile substance becomes less and the exchange of the roller can be delayed.

The object of coating with the coating tool of the present invention includes floor (floor surface), wall (wall surface), furniture (chair, table etc.) and the like. Particularly, for coating of a floor, a liquid coating agent is spread on the floor and extended, or coated on immersing an application roller in a liquid coating agent. When coating of a wide area is desired, the worker can apply coating while standing, for which the coating tool of the present invention is conveniently used.

### EXAMPLES

The present invention is explained in detail in the following by referring to Examples, which are not to be construed as limitative.

### Example 1

Using a coating tool of the present invention [application roller: paper tube having an inner diameter (φ) of 38 mm with a 13 mm thick wool cover made of oolong fiber woven fabric wound around the periphery thereof] having a constitution as shown in FIG. 1, Winup Topcoat T, trademark, GEN Maintenance Technology Inc.), an aqueous emulsion composition (photopolymerizable resin containing photoinitiator), was applied to the surface of MATICO V (trademark, manufactured by TOLI Corporation, a vinyl floor material), such that the film thickness after drying became 20 μm, with the application roller supported non-rotatably. To evaporate the solvent contained in the coating film, the floor material was stood at 20° C for 1 h. The coating film free of solvent was exposed to light at an irradiation luminous energy of 420 mJ/cm² using a high pressure mercury lamp (H05-L21, EYE GRAPHICS CO., LTD.). The smoothness of and the presence of a stagnant liquid on the coating film after curing was visually observed.

### Comparative Example 1

Using a roller rotation type coating tool rotatably supporting the application roller (roller itself), which was similar to that used in the above-mentioned Example 1, the aqueous emulsion composition used in the above-mentioned Example 1 was coated such that the film thickness after drying became 20 μm. The coating film was cured and the smoothness of and the presence of a stagnant liquid on the coating film was visually observed.

### Comparative Example 2

A floor finishing applicator (manufactured by PADCO INCORPORATED, U.S.A.) was used as a coating tool and professional floor coaters (Nylfoam and Woven Fabric) were used to apply the aqueous emulsion composition used in the above-mentioned Example 1, such that the film thickness after drying became 20μm. The coating film was cured and the smoothness of and the presence of a stagnant liquid on the coating film was visually observed.

As a result, a film (cured coating film) having a smooth surface without unevenness and free of stagnant liquid was obtained in Example 1. In Comparative Example 1, a film (cured coating film) having unevenness due to the entrainment of air bubbles inside the coating film and unevenness due to roller marks was obtained, though stagnant liquid was not observed. The film was poor in appearance. In Comparative Example 2, stagnant liquid was produced, irrespective of the kind of the cover, from which a solvent did not evaporate, and a normal coating film could not be formed.

It is clear from the foregoing explanation that the coating tool of the present invention provides coating with the periphery of the application roller in a fixed state, by non-rotatably supporting the roller at two or more predetermined positions upon rotation of the application roller about the axis thereof, and using a new part of the periphery of the application roller when the part of the periphery first used for the coating gets deteriorated due to the contact with the surface for coating. By repeating this step, almost all the surface of the periphery of the application roller can be effectively used, and coating film forming with less air bubble entrainment can be continued for a relatively long period without frequently changing an application member (application roller). In addition, since any typical application roller can be used to constitute the coating tool of the present invention, the cost necessary for the entire coating work can be greatly reduced as compared to conventional coating work.

This application is based on patent application No. 2001-091295 filed in Japan, the contents of which are hereby incorporated by reference.

What is claimed is

1. A roller fixed coating tool comprising a grip and an application roller held by a frame extended from the grip, which tool has a support structure capable of non-rotatably supporting the application roller at two or more predetermined positions upon rotation of the application roller about the axis thereof, wherein coating is done while non-rotatably supporting the application roller at each of said two or more predetermined positions.

2. The roller fixed coating tool of claim 1, wherein the support structure affords a non-rotatable support of the application roller on at least one end of the application roller.

3. The roller fixed coating tool of claim 1, wherein the application roller is non-rotatably supported at 3 or 4 predetermined positions.

4. A roller fixed coating tool comprising
an application roller having a concave to receive a bearing cap on both ends, and
a grip joined with a first frame having a protruding support shaft to support one end of the application roller and a second frame having a protruding support shaft to support the other end of the application roller, which comprises a sliding mechanism set on at least one connection between the frames and the grip to enlarge or shorten a distance between the two support shafts,
the support shafts of the aforementioned first frame and the second frame each having, on a tip thereof, a rotatable bearing cap, the bearing cap having two or more concaves for preventing rotation of the roller, at about the same intervals on a circumference of a circle concentric with the axis of the support shaft, which circle being defined on an opposite end of the bearing cap from the side where it is fitted into a concave on the end of the application roller, and said first frame and the second frame each having a pin whose tip is to be inserted into said concave for preventing rotation of the roller,
wherein the application roller is rotatably supported by sliding at least one of said first frame and the second frame and fitting the bearing cap on the tip of both support shafts into the concaves on both ends of the application roller, and
wherein the application roller is non-rotatably supported at predetermined positions about the axis upon rotation of the rotatable application roller about the axis to insert the tip of said pin into one desired concave of the two or more concaves formed on each bearing cap on both ends for preventing rotation of the roller.

5. The roller fixed coating tool of claim 4, wherein the pin is biased by a spring to normally keep the tip inserted into the concave for preventing rotation of the roller and pulled at its rear end when said tip is evacuated from the concave.

6. The roller fixed coating tool of claim 4, comprising 3 or 4 concaves for preventing rotation of the roller.

7. The roller fixed coating tool of claim 1, which is for coating an aqueous emulsion or an aqueous dispersion.

8. The roller fixed coating tool of claim 4, which is for coating an aqueous emulsion or an aqueous dispersion.
